(19) United States
(12) Patent Application Publication
(10) Pub. No.: US 2010/0110314 A1
(43) Pub. Date: May 6, 2010

(54) On-Vehicle Electronic Apparatus, Movie Reproduction Method, and Movie Reproduction Program

(76) Inventor: Manabu Kusano, Iwaki (JP)

Correspondence Address: ALPINE/BHGL, P.O. Box 10395, Chicago, IL, 60610, US

(21) Appl. No.: 12/608,165

(22) Filed: Oct. 29, 2009

(30) Foreign Application Priority Data
Oct. 30, 2008 (JP) 2008-280189

(51) Int. Cl. H04N 5/64; G08G 1/123; G06F 7/00; G01C 21/36

(52) U.S. Cl. 348/837; 340/988; 340/995.1; 701/36; 348/E05.128

(57) ABSTRACT

An on-vehicle electronic apparatus includes a vehicle-position detection unit that detects a vehicle position, a storage unit that stores therein regulation information related to movie reproduction with respect to each subject area, an area determination unit that determines the subject area corresponding to the detected vehicle-position, a regulation information extraction unit that extracts the regulation related to movie reproduction in the determined subject area from the storage unit, an output unit that selects a media source from among a plurality of media sources and outputs the selected media source, an output mode detection unit that detects an output mode of the media source selected by the output unit, a compliance determination unit that determines whether the detected output mode is compliant with the selected regulation related to movie reproduction, and an output mode determination unit that determines the output mode of the output unit based on the determination result.

### PRIORITY CLAIM

This application claims the benefit of Japanese Patent Application No. 2008-280189, filed on Oct. 30, 2008, and which is incorporated by reference herein in its entirety.

### BACKGROUND

This disclosure relates to an on-vehicle electronic apparatus, and more specifically, to control of movie reproduction by means of an on-vehicle electronic apparatus in the case where movie reproduction in the vehicle is regulated.

Along with multimedia development, an on-vehicle electronic apparatus may include a function of reproducing audio data obtained from a compact disc (CD), radio broadcasting, or the like, and may also include the function of reproducing video data obtained from a digital versatile disk (DVD), television broadcasting, or an external media device, and may further include the function of navigating a route to a destination. Furthermore, to enrich an entertainment aspect of an in-vehicle space, a plurality of displays may be installed for front seats and rear seats, the audio data may be output in a 5.1-channel surround sound, and a dual-view display may be provided that enables a driver and a passenger to view different images.

On the other hand, in view of safety, such measures are taken on such an on-vehicle apparatus as to regulate a navigating operation and to prohibit movie reproduction in certain circumstances. Japanese Patent No. 3384263 discloses a navigation device configured to detect traffic control information related to viewing of a movie in an area where the vehicle is driving, and to switch an output mode of navigation information according to the regulation condition in the area. For example, in an area where it is prohibited to view a movie in a vehicle, the navigation information is provided through sound, and, in an area where there is no regulation on viewing a movie, the navigation information is provided through both of movie and sound.

### SUMMARY

The regulations relating to movie reproduction in a vehicle may be established in accordance with municipal ordinances of each area. For example, comparing state laws in the United States, 22 states, including Washington D.C., require that “a display may be installed in a position visible to a driver, but a movie should not be shown to the driver,” 16 states, including California, require that “an installation of any device capable of reproducing a movie in front of a driver's seat is not acceptable,” and 12 states, including Ohio, have not established a specific regulation.

Few users comprehend all the regulation information in every area, and it is very cumbersome to check the regulation information in areas where the vehicle is going to travel in advance. Therefore, a person who visits the area for the first time on vacation or on business trip or a person unfamiliar with the laws may unintentionally violate the regulation. Furthermore, because the on-vehicle electronic apparatus includes a function of reproducing and displaying a plurality of media sources, it is difficult for a user to instantaneously determine regulations related to movie reproduction and switch operation in accordance therewith.

The present application in one embodiment discloses an on-vehicle electronic apparatus, a movie reproduction method, and a movie reproduction program that can solve the existing problems as described above by selecting a regulation related to movie reproduction and outputting a media source compliant with the regulation.

An on-vehicle electronic apparatus according to an embodiment of the present invention in one embodiment includes a vehicle-position detection unit configured to detect a vehicle position, a storage unit configured to store therein regulation information related to movie reproduction with respect to each area, an extraction unit configured to extract the regulation information related to movie reproduction in an area corresponding to the vehicle position detected by the vehicle-position detection unit, an output unit configured to select a media source from among a plurality of media sources and output the media source, a detection unit configured to detect an output mode of the media source selected by the output unit, a determination unit configured to determine whether the output mode detected by the detection unit is compliant with the regulation information related to movie reproduction extracted by the extraction unit, and an output control unit configured to control the output unit based on a determination result made by the determination unit.

Preferably, when the determination unit determines that the output mode is not compliant, the output control unit controls a selection of the media source through the output unit to comply with the regulation information. Furthermore, the output control unit may control the output unit to stop movie reproduction, to display a still image, and to reproduce an audio data.

The on-vehicle electronic apparatus may further include a navigation unit configured to display a road map of an area surrounding a vehicle and guides a route to a destination, and, when the determination unit determines that the output mode is not compliant with the regulation information, the output control unit may control the output unit to display a navigation image.

The on-vehicle electronic apparatus may further include an input unit configured to receive an instruction from a user so that when the input unit receives the instruction to change the media source, the determination unit can determine whether the output mode of a specified media source is compliant with the regulation information related to movie reproduction, and, when the determination unit determines that the output mode of the specified media source is not compliant with the regulation information, the output control unit can reject the instruction to change the media source. In this case, preferably, when the determination unit determines that the output mode of the specified media source is not compliant with the regulation information, the output control unit controls the output unit to output a warning that the output mode of the specified media source is not compliant with the regulation information.

Further, the output control unit includes a table showing output modes of media sources compliant with the regulation information based on relations between the output modes of the media sources and the regulation information related to movie reproduction, and controls the output unit to select the media source according to the table.

The on-vehicle electronic apparatus may further include a regulation-change detection unit configured to detect a change of the regulation information related to movie reproduction based on a guidance route selected by the navigation unit so that when the regulation-change detection unit detects change of the regulation information while the vehicle is moving, the determination unit determines the output mode is compliant with a new regulation information, and when the determination unit determines that the output mode is not compliant with the new regulation information, the output control unit controls the output unit to output a warning that the output mode may not be compliant with the new regulation information.

Moreover, the output unit may be disposed in front of a driver's seat or within the driver's field of view, and includes a display capable of displaying images on a driver's screen and a passenger's screen at a time, the determination unit may determine whether the output mode on the driver's screen and the output mode on the passenger's screen are compliant with the regulation information related to movie reproduction, and the output control unit may control a selection of the media source to be output from the output mode on the driver's screen and the output mode on the passenger's screen based on the determination result made by the determination unit. In this case, when the determination unit determines that the output mode on the driver's screen and the output mode on the passenger's screen are not compliant, the output unit may select the media source so that the output mode on the driver's screen and the output mode on the passenger's screen are an identical image. Preferably, the output control unit includes a table showing output modes of media sources compliant with the regulation information based on relations between the output modes of the media sources and the regulation information related to movie reproduction. The table may include both of the output mode on the driver's screen and the output mode on the passenger's screen and the output control unit may control the output unit to select the media source in accordance with the table.

A movie reproduction method and a movie reproduction program of an on-vehicle electronic apparatus capable of displaying a movie on a display according to an embodiment of the present invention in one embodiment includes the steps of detecting a vehicle position, obtaining regulation information related to movie reproduction in an area corresponding to the vehicle position, detecting an output mode of a media source selected by the on-vehicle electronic apparatus, determining whether the output mode is compliant with the regulation information related to movie reproduction, and selecting the media source compliant with the regulation information and outputting the media source, when it is determined that the output mode is not compliant with the regulation information related to movie reproduction.

According to an aspect of the present invention, because it is determined whether the output mode is compliant with the regulation related to movie reproduction in the area corresponding to the vehicle position, and, if it is not compliant, the output mode is switched to comply with the regulation, it is possible to prevent a user unfamiliar with the regulation from violating the regulation. In this manner, the user is free from cumbersome operations, such as searching for information related to the regulation in advance.

### BRIEF DESCRIPTION OF THE DRAWINGS

FIG. 1 is a block diagram of an on-vehicle electronic apparatus according to an embodiment of the present invention;

FIG. 2 is a schematic diagram showing an example of a data configuration for regulations related to movie reproduction;

FIG. 3 is a functional block diagram of a reproduction control program;

FIG. 4 is an example of a compliance determination table used to determine whether an output mode is compliant with the regulation;

FIG. 5 is a functional block diagram of an output mode determination unit;

FIG. 6 is a flowchart of a movie reproduction control operation according to one embodiment;

FIG. 7 is an example of a video data switch table used by the output mode determination unit;

FIGS. 8(a) and 8(b) show examples of a video data switching operation;

FIG. 9 is a flowchart of an operation performed by an on-vehicle electronic apparatus according to a second embodiment of the present invention;

FIG. 10(a) is a schematic diagram for explaining a dual-view display;

FIGS. 10(b) to 10(d) are examples of displays on a driver's screen and a passenger's screen according to a third embodiment of the present invention;

FIG. 11 is a functional block diagram of an output mode determination unit in a reproduction control program according to the third embodiment;

FIG. 12 is an example of a compliance determination table on the passenger's side; and

FIG. 13 is an example of a video data switch table according to the third embodiment.

### DETAILED DESCRIPTION

Preferable embodiments for carrying out the present invention will be described below in detail with reference to accompanying drawings. An on-vehicle electronic apparatus according to an embodiment of the present invention includes a function of reproducing a movie and a still image, a function of reproducing audio data, and a navigation function, and per a user to select one or more of these functions to output corresponding data in accordance with a regulation related to movie reproduction established with respect to each geographical area.

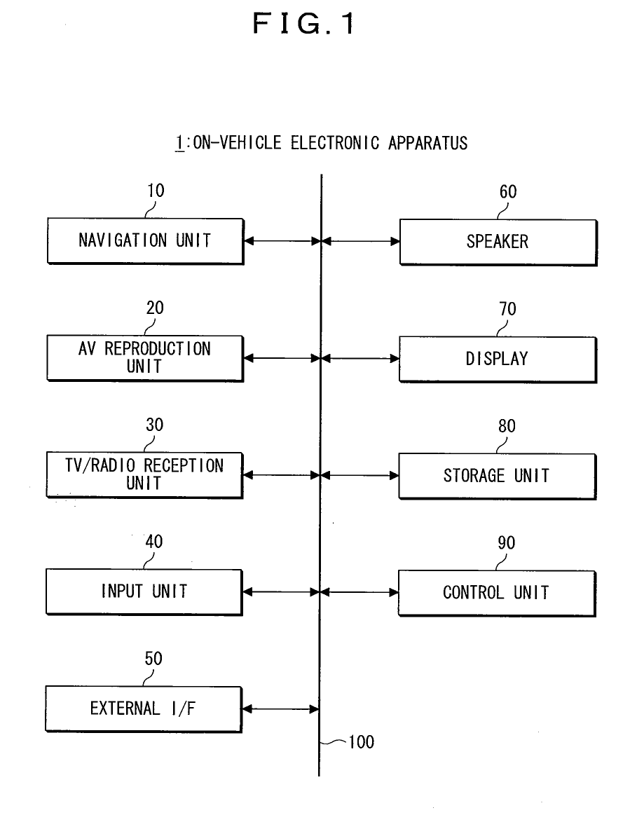

FIG. 1 is a block diagram of an on-vehicle electronic apparatus according to an embodiment of the present invention. An on-vehicle electronic apparatus 1 includes a navigation unit 10, an audio video (AV) reproduction unit 20, a TV/radio reception unit 30, input unit 40, an external interface (I/F) 50, a speaker 60 that outputs audio data, a display 70 that outputs video data, a storage unit 80 including a high-capacity hard disk device and a semiconductor memory device, an extraction unit (not shown) that extracts regulation information from the storage unit 80, an output unit (not shown) that outputs a media source, a detection unit (not shown) that detects an output mode of the media source, a determination unit (not shown) that determines whether the output mode is compliant with regulation information, and an output control unit (not shown) that controls the output unit based on the determination result made by the determination unit, as well as a control unit 90 that controls the components described above and an internal bus 100 that connects them one another.

The navigation unit 10 includes a vehicle-position detection unit that detects a vehicle position based on data received from a global positioning system (GPS) satellite or a gyro sensor. The navigation unit 10 detects the vehicle position using the vehicle-position detection unit, reads road map data around the vehicle from the storage unit 80, and displays the road map data on the display 70. Furthermore, the navigation unit 10 performs guidance of a route to the destination through searching a guidance route to a destination based on the destination and search conditions inputted from the input unit 40.

The AV reproduction unit 20 reproduces audio data and/or video data stored in a recording media such as a compact disk (CD), a digital versatile disk (DVD), a Blu-ray (registered trademark) disc, or an external media device, and outputs the reproduced data from the speaker 60 and the display 70.

The TV/radio reception unit 30 includes a tuner that receives television broadcasting, such as digital terrestrial broadcasting and radio broadcasting via an antenna. Broadcast signals received by the tuner are separated into video data, audio data, and text data, which are output from the speaker 60 and the display 70.

The input unit 40 includes, for example, a touch screen, an input key, and a remote controller, and provides the on-vehicle electronic apparatus 1 with information input from a user, such as a selection of the media source, a volume controller, and a selection of a broadcasting station. The external I/F 50 connects the external media device to the on-vehicle electronic apparatus 1 via a wired communication, such as a cable or a wireless communication protocol, such as infrared communication or Bluetooth (registered trademark). By connecting the external media device, the on-vehicle electronic apparatus 1 can output the audio data and the video data stored in the external media device.

The storage unit 80 stores therein various data. For example, the storage unit 80 stores therein the road map data including roads and buildings required for navigation, regulation information related to movie reproduction enforced or established in geographical areas, such as municipalities, counties, or states, and a compliance determination table used to determine whether an output mode is compliant with the regulation related to movie reproduction to be described later. Hereinafter, a unit of the areas such as the prefectures, counties, municipalities, and states that establish the regulation related to movie reproduction under the ordinance is referred to as “subject area”. Furthermore, the “regulation” used herein includes statutes, laws, ordinances, and rules, and it is used in a broad sense including an instruction and/or a warning accompanying.

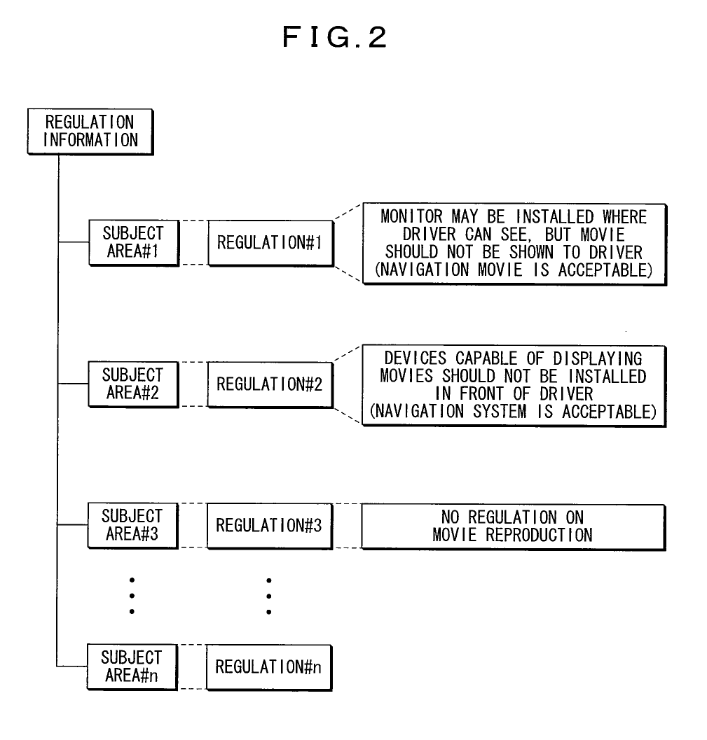

FIG. 2 shows an example of the regulations related to movie reproduction. The storage unit 80 stores therein, as shown in FIG. 2, regulations related to movie reproduction established with respect to each subject area (subject area #1, subject area #2, . . . , and subject area #n). The regulation information may be stored in the form of text information, or may be features extracted of the regulation. The form in which the information is stored does not matter. The regulation information can be obtained from an external server that stores therein the regulation information via the external I/F 50, and, when a law is revised, the regulation information can be updated by obtaining legal revision information through the external I/F 50.

For example, a regulation #1 is enforced in a subject area #1, and the regulation #1 regulates that “a monitor may be installed where a driver can see, but a movie should not be shown to the driver (a navigation movie is acceptable).” Therefore, it would be a violation to display a movie on a display installed near a windshield of a car while the car is moving, but a still image or a navigation movie may be displayed.

A regulation #2 is enforced in a subject area #2, and the regulation #2 regulates that “a device capable of displaying a movie should not be installed in front of a driver's seat or within the driver's field of view (a navigation system is acceptable).” Therefore, it would be a violation to install a display for viewing television broadcasting and a DVD alone near the windshield. A regulation #3 is enforced in a subject area #3, and the regulation #3 does not include any regulation related to movie reproduction. Therefore, a video data can be freely displayed on a display.

The control unit 90 includes a memory that stores therein a computer program for controlling the on-vehicle electronic apparatus 1, a central processing unit that executes the computer program, and the like. The computer program includes a reproduction control program for controlling movie reproduction based on the regulation information related to movie reproduction in the subject area where the vehicle is travelling, in addition to controlling the navigation unit 10, the AV reproduction unit 20, and the TV/radio reception unit 30.

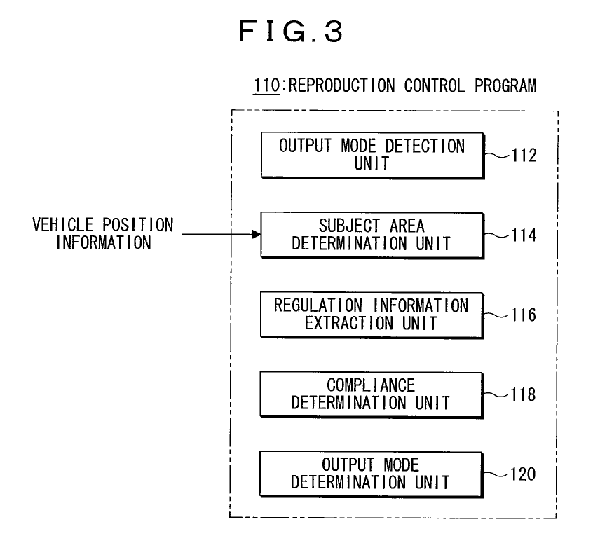

FIG. 3 is a functional block diagram of the reproduction control program in the control unit 90. A reproduction control program 110 includes an output mode detection unit 112 that detects an output mode of the on-vehicle electronic apparatus 1, an area determination unit 114 that determines the subject area in which the vehicle is travelling, a regulation information extraction unit 116 that extracts the regulation information related to movie reproduction in the subject area determined by the area determination unit 114 from the storage unit 80, a compliance determination unit that determines whether the output mode is compliant with the regulation in the subject area, and an output mode determination unit 120 that determines an output mode compliant with the regulation if the output mode is not compliant with the regulation.

The output mode detection unit 112 identifies a media source executed or selected by the on-vehicle electronic apparatus 1, and determines how the media source is output. The media source herein means content information that can be output from the on-vehicle electronic apparatus 1, including a CD, a DVD, a Blu-ray disc, a television, a radio, a navigation system, an external media device, or any other suitable component. The output modes include an image output and a still image output to the display, a sound output to the speaker, and the like.

The area determination unit 114 obtains vehicle position information from the navigation unit 10, and determines the subject area based on the vehicle position information. For example, the area determination unit 114 determines the subject area with a latitude and a longitude indicated by the vehicle position information.

The regulation information extraction unit 116 reads the regulation information applicable to the subject area determined by the area determination unit 114 from the storage unit 80, and extracts the regulation information. The compliance determination unit 118 compares the read regulation information to the output mode detected by the output mode detection unit 112, and determines whether the output mode is compliant with the regulation.

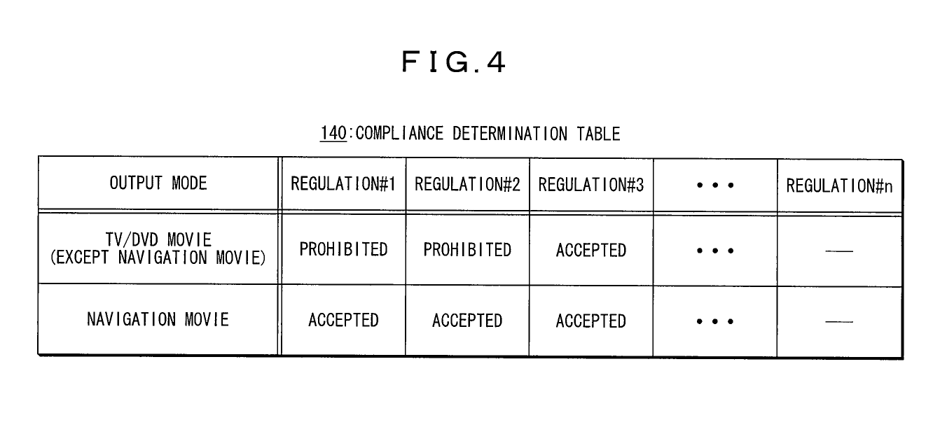

FIG. 4 is an example of the compliance determination table used to determine whether the output mode is compliant with the regulation. The compliance determination table 140 is a table showing relations or correspondence between the regulation information in subject areas and output modes to the display. In this case, the display is installed in front of the driver's seat or within the driver's field of view. The output modes to the display include a TV/DVD movie mode of reproducing video data obtained from the television broadcasting or the DVD, and a navigation movie mode by the navigation unit 10. The TV/DVD movie mode is prohibited by the regulations #1 and #2 (refer to FIG. 2), but it is accepted by the regulation #3. A navigation image is not prohibited by any of the regulations. By preparing such a compliance determination table 140 in advance, the compliance determination unit 118 can easily determine whether the output mode is compliant with the regulation, thereby saving time for determination.

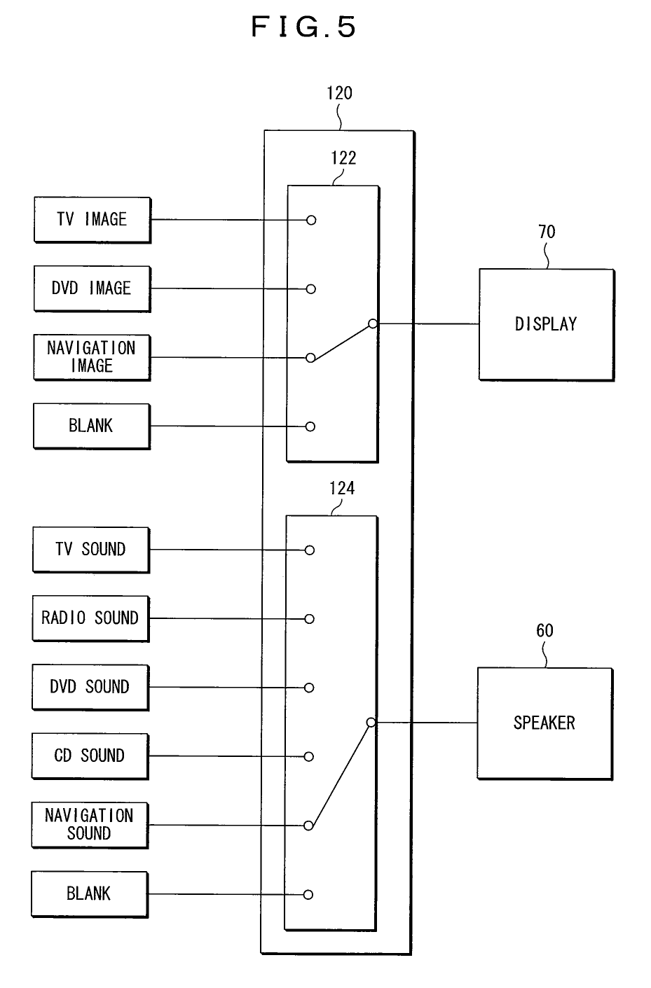

FIG. 5 is a functional block diagram of the output mode determination unit 120. The output mode determination unit 120 includes a video selection unit 122 that selects video data from a plurality of media sources, and an audio selection unit 124 that selects audio data from a plurality of media sources, based on the determination result made by the compliance determination unit 118. The video selection unit 122 includes input terminals for a television image, a DVD (including Blu-ray and the like) image, a navigation image, and a blank, of which one is selected, and an output terminal for supplying data from the selected input to the display 70. When the video selection unit 122 selects the input for the blank, no video data is output to the display 70, and the display 70 is in an off state. Otherwise, a still image may be stored in the storage unit 80 in advance, so that the still image is supplied to the display 70 when the input for the blank is selected. The audio selection unit 124 selects one of a television sound, a radio sound, a CD sound, a DVD (including Blu-ray and the like) sound, a navigation sound, and a blank, to be supplied to the speaker 60.

When the vehicle stops, thus rendering the regulation related to movie reproduction inapplicable, the output mode determination unit 120 selects any media source in response to an instruction from the user. For example, when the user selects the television, the video selection unit 122 selects the television image, which is displayed on the display 70. The audio selection unit 124 also selects the television sound, which is output from the speaker 60.

On the other hand, when the vehicle starts travelling, the video selection unit 122 selects the media source so as not to violate the regulation related to movie reproduction. The audio selection unit 124 may switch the media source based on the selection by the video selection unit. Furthermore, when the vehicle enters a subject area in which there is no regulation related to the movie from another subject area in which there is any regulation related to the move while the vehicle is travelling, the video selection unit 122 performs switch control of the media sources on demand.

For example, when the vehicle enters a subject area in which movie reproduction is prohibited while the television movie is output, the video selection unit 122 switches from the television image to the navigation image, and the audio selection unit 124 switches from the television audio to the navigation audio. When the vehicle reenters the subject area in which there is no regulation, the video selection unit 122 may select the television image and display it on the display. Furthermore, even when the television image is displayed, the video selection unit 122 may automatically switch to the navigation image to preferentially display the navigation function such as a guide at an intersection. Moreover, the output mode determination unit 120 may be configured to reject an input if the user inputs an instruction to reproduce a movie in the subject area in which movie reproduction is prohibited.

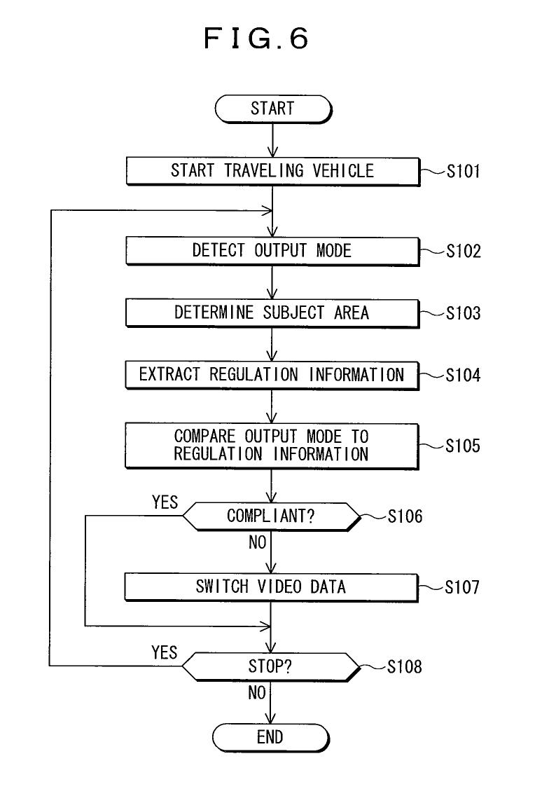

A movie reproduction operation performed by the on-vehicle electronic apparatus according to the embodiment is described with reference to a flowchart shown in FIG. 6. When the vehicle starts travelling (Step S101), the navigation unit 10 supplies a signal indicative of the start of travelling to the output mode detection unit 112. In response to the signal, the output mode detection unit 112 detects the output mode (Step S102). The output mode can be detected by, for example, detecting which input is selected by the video selection unit 122 shown in FIG. 5.

Next, the area determination unit 114 receives the vehicle position information from the navigation unit 10, and determines the subject area corresponding to the vehicle (Step S103). The regulation information extraction unit 116 then extracts the regulation information corresponding to the determined subject area from the storage unit 80 (Step S104).

Then, the compliance determination unit 118 compares the extracted regulation information to the detected output mode (Step S105), and determines whether the output mode is compliant with the regulation (Step S106). Preferably, the determination is performed using the compliance determination table 140 as described above.

When the compliance determination unit 118 determines that the output mode is compliant with the regulation, the output mode determination unit 120 retains the output mode as it is. On the other hand, when the compliance determination unit 118 determines that the output mode is not compliant with the regulation, the output mode determination unit 120 makes the video selection unit 122 stop movie reproduction, and switches to select either the navigation image or the blank (Step S107). If the vehicle is travelling, the process returns to Step S102. However, the process at Step S102 and later may be performed after a predetermined time period, or when the vehicle enters another subject area.

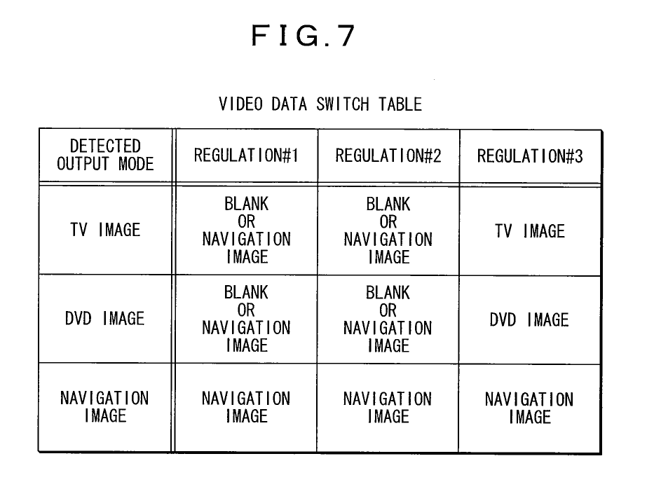

FIG. 7 is an example of a video data switch table. As described above, the output mode determination unit 120 switches the video data depending on whether the output mode is compliant with the regulation. In this case, the video data switch table as shown in FIG. 7 may be stored in the storage unit 80 in advance, and the video data may be selected based on the table. For example, when the vehicle enters the subject area with the regulation #1 while the television image is selected as the output mode, the video selection unit 122 selects either the blank (including the still image) or the navigation image. The same operation is performed also in the subject area with the regulation #2. In the case of the subject area with the regulation #3, because there is no regulation, the output mode is retained as it is. Naturally, other than using such a table, a priority order for selecting the video data may be determined in advance, based on which the video data compliant with the regulation may be selected.

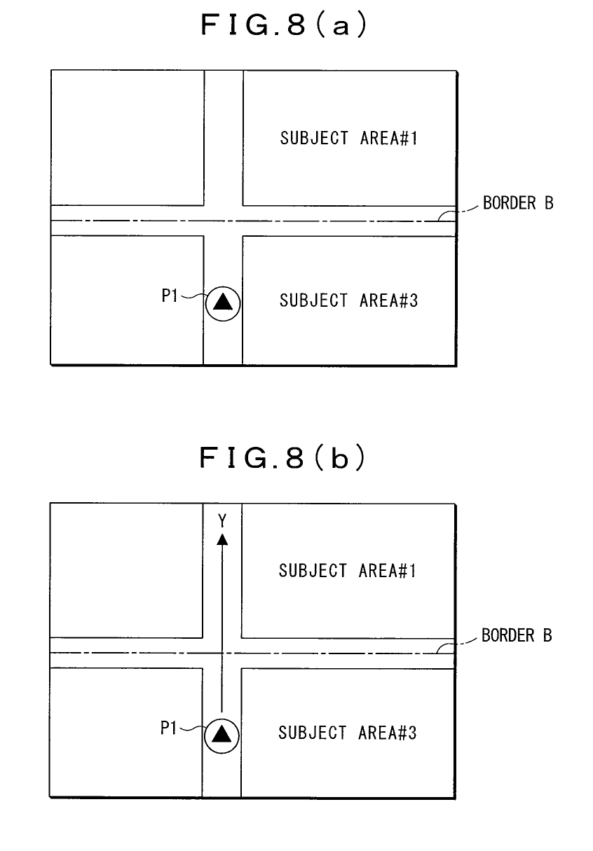

FIG. 8(a) shows another example of a video data switching operation. As shown in FIG. 8(a), it is assumed that the vehicle is travelling in the subject area #3 and enters the subject area #1 beyond a border B. When the vehicle enters the subject area #1 with a movie reproduced on the display in front of the driver's seat (within the driver's field of view) in the subject area #3, the video selection unit 122 selects either the blank so that the output of the movie to the display stops, or the navigation image other than a movie. The audio selection unit 124 may be configured to subsequently output the television sound if the television image is output at the time, or to subsequently output the DVD sound if the DVD image is output.

When a guidance route Y to the destination is set and the guidance route Y leads from the subject area #3 to the subject area #1 as shown in FIG. 8(b), the reproduction control program 100 can detect in advance that the subject area will change and the regulation related to movie reproduction will also change, based on the guidance route Y. When such a result is obtained from the detection, the compliance determination unit 118 can determine whether the output mode is compliant with the regulation before the vehicle enters the subject area #1.

When it is detected that there will be a change between the subject area #3 and the subject area #1 in the travelling direction on the guidance route Y, the area determination unit 114 determines that the vehicle position is in the subject area #1, and the regulation information extraction unit 116 extracts the regulation information related to movie reproduction of the subject area #1 from the storage unit 80. The compliance determination unit 118 then determines whether the current output mode detected by the output mode detection unit 112 is compliant with the regulation in the subject area #1. If it is not compliant, the reproduction control program 110 may be configured to provide a notice of the fact to the user in advance to provide the user with an opportunity to switch the video data. The reproduction control program may also be configured to show the regulation in the subject area #1.

On the contrary to the example shown in FIG. 8(b), when it is possible to determine in advance that the vehicle enters from the subject area with the regulation to the subject area #3 with no regulation, the reproduction control program 110 can show the notice of the fact to the user to provide the opportunity to switch the video data.

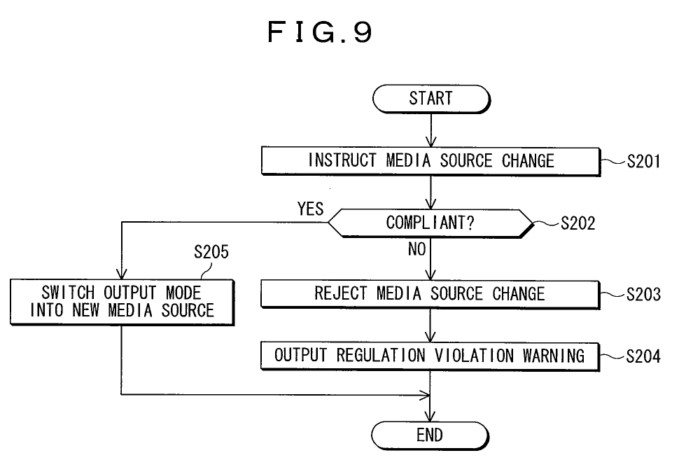

Next, a second embodiment of the present invention is described. The second embodiment relates to a process performed when the user instructs a change to the media source in the subject area where movie reproduction is prohibited. FIG. 9 is a flowchart of an operation performed by an on-vehicle electronic apparatus according to the second embodiment.

When the user instructs the change of the media source through the input unit 40 (Step S201), the compliance determination unit 118 compares the output mode of the specified media source to the regulation related to movie reproduction in the subject area, and determines whether the output mode of the specified media source is compliant with the regulation (Step S202). When it is determined that the output mode is not compliant, the output mode determination unit 120 rejects the change of the media source instructed by the user (Step 203) to retain the current output mode, and outputs a warning such as “reproduction of the video data violates the regulation” prepared in advance from the display or the speaker (Step S204). On the other hand, when it is determined that the output mode is compliant, the output mode determination unit 120 switches the output mode to the specified media source (Step S205).

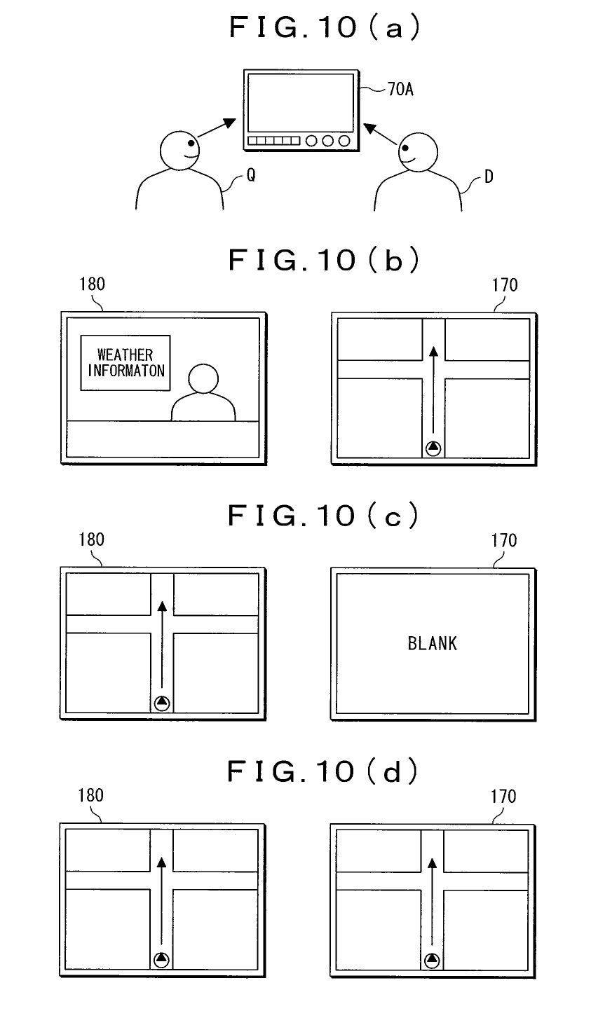

Next, a third embodiment of the present invention is described. The third embodiment relates to a process performed using a dual-view liquid crystal display capable of displaying two images at a time. The dual-view display is configured to display different images to the left and the right at a time by providing a filter called a parallax barrier on the display, thereby separating a light from a backlight into two directions of the left and the right. The dual-view display can be also used as a general single-view display by outputting an identical image to both screens on the left and the right. As shown in FIG. 10(a), it is possible to dispose a dual-view display 70A near the windshield, thereby showing different images to a driver D and a passenger Q.

As shown in FIG. 2, the regulation related to movie reproduction in the subject area #1 is applied only to the driver but not to the passenger. On the other hand, the regulation related to movie reproduction in the subject area #2 is applied to both the driver and the passenger. Therefore, according to the third embodiment, a switch control of images displayed on the dual-view display is performed depending on the regulation.

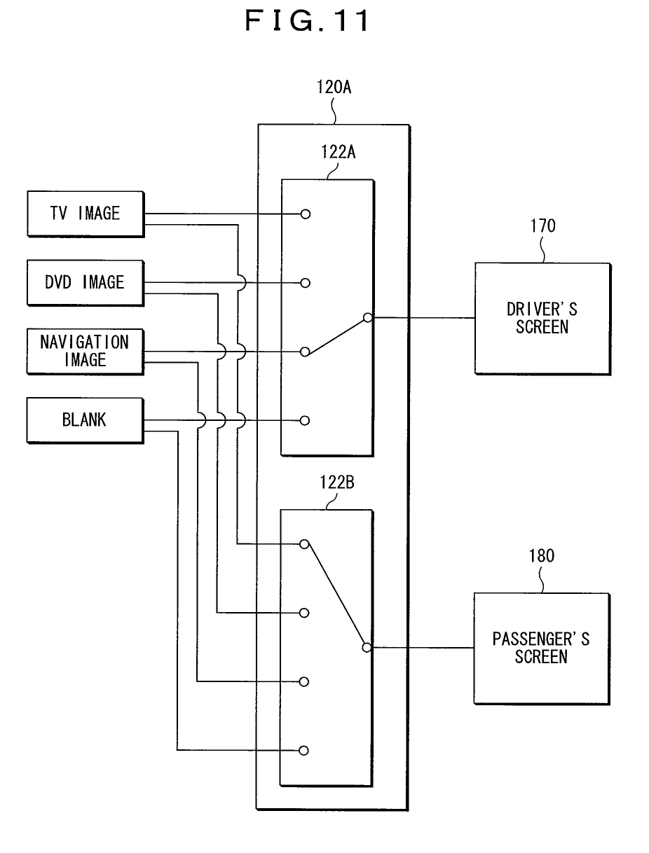

FIG. 11 is a functional block diagram of an output mode determination unit in a reproduction control program according to the third embodiment. An output mode determination unit 120B includes a first video selection unit 122A and a second video selection unit 122B. An input terminal of the first video selection unit 122A is connected to a television image, a DVD (including Blu-ray and the like) image, a navigation image, and a blank (including a still image), and the output terminal thereof is connected to a driver's screen 170. An input terminal of the second video selection unit 122B is connected in the same manner as the first video selection unit 122A, but the output thereof is connected to a passenger's screen 180. Each of the first and the second video selection units 122A and 122B can operate independently to provide each of the driver's screen 170 and the passenger's screen 180 of the dual-view display 70A with an image.

The output mode detection unit 112 detects the output mode of the dual-view display 70A. Preferably, the output mode detection unit 112 detects the output mode from the input selected by the video selection units 122A and 122B shown in FIG. 11. The compliance determination unit 118 compares the regulation information related to movie reproduction of the subject area in which the vehicle is travelling or going to travel to the detected output mode, and determines whether each of the output modes on the driver's screen 170 and the passenger's screen 180 is compliant with the regulation. When it is determined that the output mode is compliant, the output mode is retained as it is. When it is determined that the output mode is not compliant, the output mode determination unit 120A performs the switch control on the video selection units 122A and 122B so as to comply with the regulation.

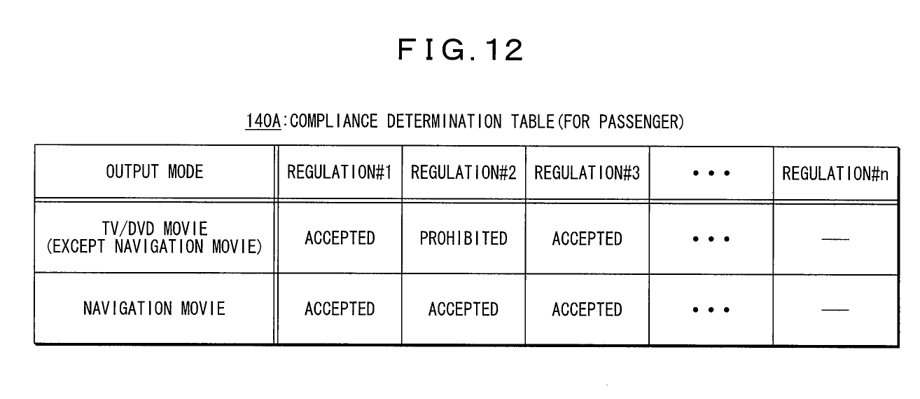

The compliance determination unit 118 may use a compliance determination table 140A as shown in FIG. 12 to determine whether the detected output mode is compliant with the regulation. The compliance determination table 140 shown in FIG. 4 is used to determine the compliance of the driver's screen 170, and the compliance determination table 140A is used to determine the compliance of the passenger's screen 180.

For example, when the vehicle is travelling in the subject area #1, because movie reproduction is prohibited, the video selection unit 122A selects either the navigation image or the blank for the driver's screen 170. On the other hand, because movie reproduction is not prohibited, the video selection unit 122B can select the television image or the DVD image for the passenger's screen 180. FIG. 10(b) shows an example in which the navigation image is displayed on the driver's screen 170 and the television image is displayed on the passenger's screen 180.

When the vehicle is travelling in the subject area #2, movie reproduction is prohibited for both the driver's screen and the passenger's screen. Therefore both the first video selection unit 122A and the second video selection unit 122B select either the navigation image or the blank. FIG. 10(c) shows an example in which the blank is displayed on the driver's screen 170 and the navigation image is displayed on the passenger's screen 180.

Furthermore, when the vehicle enters from the subject area #3 with no regulation into the subject area #1 with the regulation on the driver, the output mode determination unit may switch the dual-view display into the single-view display. In this case, both the first video selection unit 122A and the second video selection unit 122B select the same input compliant with the regulation. FIG. 10(d) shows an example in which the navigation image is displayed on the driver's screen 170 and the television image is displayed on the passenger's screen 180.

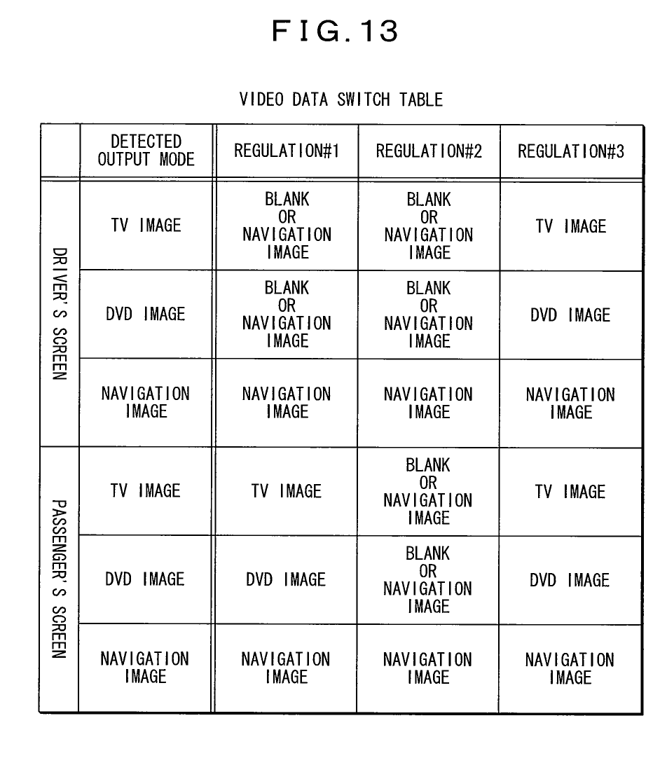

FIG. 13 is an example of a video data switch table according to the third embodiment. The output mode determination unit 120A may be configured to perform the switch control on the first video selection unit 122A and the second video selection unit 120B with reference to such a video data switch table as shown in FIG. 13.

Although preferred embodiments of the present invention have been described in detail, the present invention is not limited to these specific embodiments of the present invention. Rather, various modifications and changes can be made without departing from the scope of the present invention as described in the accompanying claims. Accordingly, all such modifications are intended to be included within the scope of this invention as defined in the following claims.

Although the on-vehicle electronic apparatus according to the above embodiments employs the navigation unit, the AV reproduction unit (CD, DVD, Blu-ray disc, and the like), the TV/radio reception unit, and the external media device, as the media sources, it is merely an example, and the present invention is not limited to this configuration. For example, the media for reproduction of the movie can include only a television receiver, or an AV reproduction device.

What is claimed is:

1. An on-vehicle electronic apparatus comprising:
a vehicle-position detection unit configured to detect a vehicle position;
a storage unit configured to store therein regulation information related to movie reproduction with respect to a plurality of areas;
an extraction unit configured to extract the regulation information related to movie reproduction in an area corresponding to the vehicle position detected by the vehicle-position detection unit;
an output unit configured to select a media source from among a plurality of media sources and output the media source;
a detection unit configured to detect an output mode of the media;
a determination unit configured to determine whether the output mode is compliant with the regulation information; and
an output control unit configured to control the output unit based on the determination made by the determination unit.

2. The on-vehicle electronic apparatus according to claim 1, wherein, when the determination unit determines that the output mode is not compliant, the output control unit controls a selection of the media source to comply with the regulation information.

3. The on-vehicle electronic apparatus according to claim 2, wherein the output control unit controls the output unit to stop movie reproduction.

4. The on-vehicle electronic apparatus according to claim 3, wherein the output control unit controls the output unit to reproduce audio data.

5. The on-vehicle electronic apparatus according to claim 2, wherein the output control unit controls the output unit to display a still image.

6. The on-vehicle electronic apparatus according to claim 1, further comprising a navigation unit configured to display a road map of an area surrounding a vehicle and a route to a destination; wherein
when the determination unit determines that the output mode is not compliant with the regulation information, the output control unit controls the output unit to display a navigation image.

7. The on-vehicle electronic apparatus according to claim 1, further comprising an input unit configured to receive an instruction from a user; wherein
when the input unit receives an instruction to change the media source, the determination unit determines whether the output mode of a specified media source is compliant with the regulation information related to movie reproduction; and
when the determination unit determines that the output mode of the specified media source is not compliant with the regulation information, the output control unit rejects the instruction to change the media source.

8. The on-vehicle electronic apparatus according to claim 7, wherein when the determination unit determines that the output mode of the specified media source is not compliant with the regulation information, the output control unit controls the output unit to output a warning that the output mode of the specified media source is not compliant with the regulation information.

9. The on-vehicle electronic apparatus according to claim 1, wherein the output control unit includes a table indicating output modes of media sources compliant with the regulation information based on a correspondence between the output modes of the media sources and the regulation information, and controls the output unit to select the media source according to the table.

10. The on-vehicle electronic apparatus according to claim 6, further comprising a regulation-change detection unit configured to detect a change of the regulation information related to movie reproduction based on a guidance route selected by the navigation unit; wherein
when the regulation-change detection unit detects the change of the regulation information while the vehicle is moving, the determination unit determines if the output mode is compliant with a new regulation information; and
if the determination unit determines that the output mode is not compliant with the new regulation information, the output control unit controls the output unit to output a warning indicating that the output mode is not compliant with the new regulation information.

11. The on-vehicle electronic apparatus according to claim 1, wherein
the output unit is disposed in a driver's field of view and includes a display capable of displaying images on a driver's screen and a passenger's screen at a time;
the determination unit determines whether the output mode corresponding to the driver's screen and the output mode corresponding to the passenger's screen are compliant with the regulation information related to movie reproduction; and
the output control unit controls a selection of the media source to be output on the driver's screen and the output mode on the passenger's screen based on the determination result made by the determination unit.

12. The on-vehicle electronic apparatus according to claim 11, wherein when the determination unit determines that the output mode on the driver's screen or the output mode on the passenger's screen are not compliant, the output unit selects the media source so that the output mode on the driver's screen and the output mode on the passenger's screen are an identical image.

13. The on-vehicle electronic apparatus according to claim 12, wherein
the output control unit includes a table indicating output modes of media sources compliant with the regulation information based on correspondence between the output modes of the media sources and the regulation information, the table including both the output mode on the driver's screen and the output mode on the passenger's screen, and
the output control unit controls the output unit to select the media source according to the table.

14. A movie reproduction method of an on-vehicle electronic apparatus capable of displaying a movie on a display, the method comprising the steps of:
detecting a vehicle position;
obtaining regulation information relating to movie reproduction in a geographical area corresponding to the vehicle position;
detecting an output mode of a media source selected by the on-vehicle electronic apparatus;
determining whether the output mode is compliant with the regulation information; and
selecting the media source compliant with the regulation information and outputting the media source, if it is determined that the output mode is not compliant with the regulation information.

15. The movie reproduction method according to claim 14, wherein information other than movie reproduction is output at the outputting step.

16. The movie reproduction method according to claim 14, further comprising the steps of:
inputting an instruction to change the media source;
determining whether the output mode of a specified media source is compliant with the regulation information; and
rejecting the instruction to change the media source when it is determined that the output mode of the specified media source is not compliant with the regulation information.

17. The movie reproduction method according to claim 14, further comprising the steps of:
determining, when the display disposed in a driver's field of view includes the output mode on a driver's screen and the output mode on a passenger's screen, whether the output mode on the driver's screen and the output mode on the passenger's screen are compliant with the regulation information; and
controlling a selection of the media source to be output from the output mode on the driver's screen and the output mode on the passenger's screen based on a result of the determining step.

18. A movie reproduction program executed by an on-vehicle electronic apparatus capable of displaying a movie on a display, the program comprising the steps of:
detecting a vehicle position;
obtaining regulation information relating to movie reproduction in a geographical area corresponding to the vehicle position;
detecting an output mode of a media source selected by the on-vehicle electronic apparatus;
determining whether the output mode is compliant with the regulation information; and
selecting the media source compliant with the regulation information and outputting the media source, if it is determined that the output mode is not compliant with the regulation information related to movie reproduction.

19. The movie reproduction program according to claim 18, wherein information other than movie reproduction is output at the step of outputting.

20. The movie reproduction program according to claim 18, further comprising the steps of:
inputting an instruction to change the media source;
determining whether the output mode of a specified media source is compliant with the regulation information; and
rejecting the instruction to change the media source when it is determined that the output mode of the specified media source is not compliant with the regulation information.
